(19) United States
(12) Patent Application Publication
(10) Pub. No.: US 2020/0162843 A1
(43) Pub. Date: May 21, 2020

(54) FINITE PROXIMITY NOTIFICATION SYSTEM

(71) Applicant: Latchkey, Inc., Washington, DC (US)

(72) Inventors: Stephen E. BOLEN, St. Louis, MO (US); Jonathan T. GREGORY, Hummelstown, PA (US); Isaac I. YATES, Falls Church, VA (US)

(21) Appl. No.: 16/676,545

(22) Filed: Nov. 7, 2019

Related U.S. Application Data
(60) Provisional application No. 62/768,526, filed on Nov. 16, 2018.

(51) Int. Cl. H04W 4/021; H04W 4/02; H04B 17/318; H04W 4/80; H04W 4/14; H04W 8/00; H04W 68/00

(52) U.S. Cl. CPC H04W 4/022; H04W 4/023; H04B 17/318; H04W 68/005; H04W 4/14; H04W 8/005; H04W 4/80

(57) ABSTRACT

A system and method for tracking a wireless-enabled device. The system can include a hub configured to communicably connect via a wireless communication protocol to the wireless-enabled device and a back-end computer system configured to connect to the hub and a user device. The method can include setting a virtual boundary according to a threshold signal strength between the wireless-enabled device and the hub. Once the virtual boundary is set, the hub, back-end computer system, and/or user device can execute logic to send various notifications to users based on the wireless-enabled devices entering and exiting the virtual boundary, as determined by the wireless signal strength between the wireless-enabled devices and the hub.

### PRIORITY

The present application claims priority under 35 U.S.C. § 119(e) to U.S. Provisional Patent Application Ser. No. 62/768,526, titled GEO-FENCING NOTIFICATION SYSTEM, filed Nov. 16, 2018, the disclosure of which is herein incorporated by reference in its entirety.

### BACKGROUND

The present disclosure generally relates to geo-fencing and wireless notification systems, without the use of Global Positioning System (“GPS”) or cellular networks, that can be utilized to track the movement of individuals, pets, and/or objects with respect to their crossing in either direction (e.g., entering and exiting) a virtual boundary and provide notifications accordingly. Present geo-fencing and wireless notification systems for tracking the movement of individuals, pets, and/or objects have a number of technical problems, which can include being reliant upon GPS or cellular networks and being tied to the manipulation of physical security devices (e.g., locks). Systems and methods for solving these limitations with present systems are described below.

### SUMMARY

In one general aspect, a hub configured to communicably connect via a wireless communication protocol to a wireless-enabled device. The hub can comprise a processor and a memory coupled to the processor. The memory can store instructions that, when executed by the processor, cause the hub to: receive a command to set a threshold distance; determine a signal strength of a wireless connection between the wireless-enabled device and the hub; store the signal strength corresponding to the threshold distance as a threshold signal strength; wherein the threshold distance defines a virtual boundary about the hub; and after recordation of the threshold signal strength: determine the wireless connection established between the hub and the wireless-enabled device; determine the signal strength of the wireless connection; compare the signal strength of the wireless connection to the threshold signal strength; and transmit a notification to a recipient based on the comparison of the signal strength and the threshold signal strength; wherein the notification indicates that the wireless-enabled device has crossed the virtual boundary.

In another general aspect, a back-end computer system configured to communicably connect to a hub and a client device, the hub configured to communicably connect via a wireless communication protocol to a wireless-enabled device. The back-end computer system can comprise a processor and a memory coupled to the processor. The memory can store instructions that, when executed by the processor, cause the back-end computer system to: receive, from the client device, a command to set a threshold distance; transmit the command to the hub; receive, from the hub, a signal strength of a wireless connection between the wireless-enabled device and the hub; store the signal strength corresponding to the threshold distance as a threshold signal strength; wherein the threshold distance defines a virtual boundary about the hub; and after recordation of the threshold signal strength: receive, from the hub, the signal strength of the wireless connection; compare the signal strength of the wireless connection to the threshold signal strength; and transmit a notification to the client device based on the comparison of the signal strength and the threshold signal strength; wherein the notification indicates that the wireless-enabled device has crossed the virtual boundary.

In another general aspect, a computer-implemented method for tracking a wireless-enabled device via a hub, the hub configured to communicably connect via a wireless communication protocol to the wireless-enabled device. The method can comprise: receiving, by the hub, a command to set a threshold distance; determining, by the hub, a signal strength of a wireless connection between the wireless-enabled device and the hub; storing, by the hub, the signal strength corresponding to the threshold distance as a threshold signal strength; wherein the threshold distance defines a virtual boundary about the hub; and after recordation of the threshold signal strength: determining, by the hub, the wireless connection established between the hub and the wireless-enabled device; determining, by the hub, the signal strength of the wireless connection; comparing, by the hub, the signal strength of the wireless connection to the threshold signal strength; and transmitting, by the hub, a notification to a recipient based on the comparison of the signal strength and the threshold signal strength; wherein the notification indicates that the wireless-enabled device has crossed the virtual boundary.

### FIGURES

The various aspects described herein, both as to organization and methods of operation, together with further objects and advantages thereof, may best be understood by reference to the following description, taken in conjunction with the accompanying drawings as follows.

FIG. 1 is a diagram of a geo-fencing notification system, in accordance with at least one aspect of the present disclosure.

FIG. 2 is a block diagram of the geo-fencing notification system, in accordance with at least one aspect of the present disclosure.

FIG. 3 is a logic flow diagram of a process of establishing a virtual boundary, in accordance with at least one aspect of the present disclosure.

FIG. 4 is a state machine diagram of a geo-fencing notification system, in accordance with at least one aspect of the present disclosure.

FIG. 5 is a logic flow diagram of a process for notifying a user when an individual enters a virtual boundary, in accordance with at least one aspect of the present disclosure.

FIG. 6 is a logic flow diagram of a process for notifying a user when an individual leaves a virtual boundary, in accordance with at least one aspect of the present disclosure.

### DESCRIPTION

Certain aspects will now be described to provide an overall understanding of the principles of the structure, function, manufacture, and use of the devices and methods disclosed herein. One or more examples of these aspects are illustrated in the accompanying drawings. Those of ordinary skill in the art will understand that the devices and methods specifically described herein and illustrated in the accompanying drawings are non-limiting example aspects and that the scope of the various aspects is defined solely by the claims. The features illustrated or described in connection with one aspect may be combined with the features of other aspects. Such modifications and variations are intended to be included within the scope of the claims. Furthermore, unless otherwise indicated, the terms and expressions employed herein have been chosen for the purpose of describing the illustrative aspects for the convenience of the reader and not to limit the scope thereof.

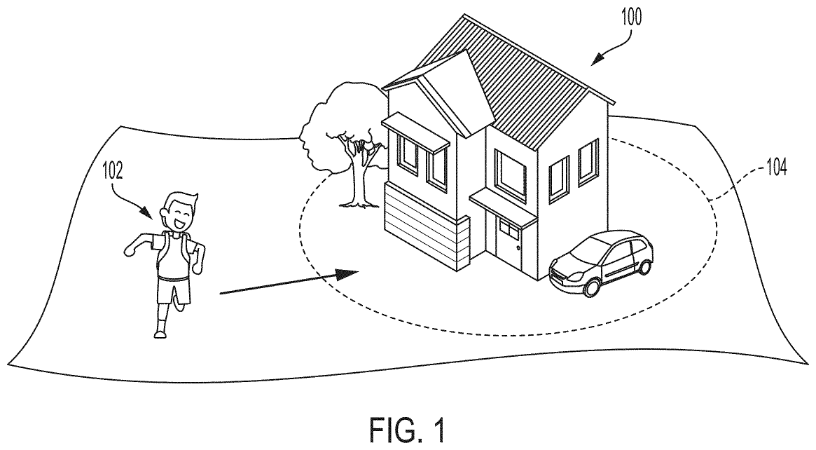

The present disclosure generally describes a finite proximity or geo-fence notification system that uses a hub to wirelessly monitor the proximity of a wireless-enabled device, which can also be referred to as a “beacon” or a “tag,” and sends a notification (e.g., a push notification via an app, text message, or email) to a subscribed user based upon the movement of the wireless-enabled device with respect to crossing the geo-fenced boundary. To illustrate this concept, FIG. 1 illustrates an implementation of the geo-fence notification system where parents can plug the hub in at home 100, connect the hub to WFi, configure which wireless-enabled device(s) the hub should monitor, and establish the range of the virtual boundary 104, for example. When a child 102 carrying a paired wireless-enabled device comes home from school and crosses this virtual boundary 104, the hub can wirelessly detect the presence of the wireless-enabled device and trigger a notification to be sent to the parent or guardian's smartphone or email. Accordingly, the geo-fence notification system can alert parents when their children come home from school in a simple and intuitive manner, thereby providing parents with the peace of mind to know that nothing is amiss with their children. The process requires no manual actions on behalf of the child, and does not use GPS or cellular networks for configuration or monitoring.

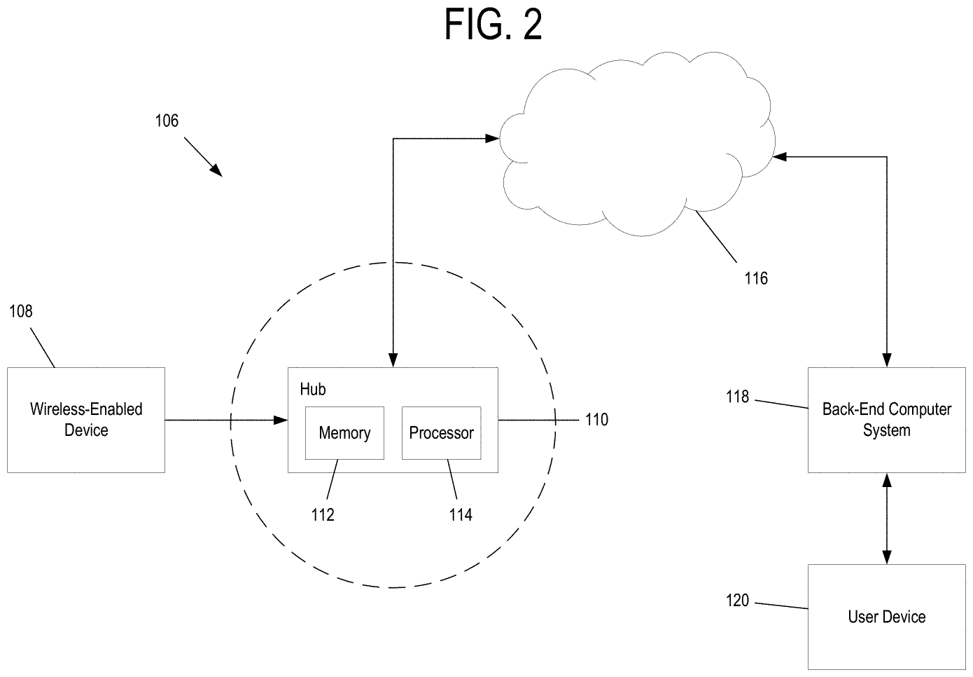

FIG. 2 is a block diagram of the geo-fencing notification system 106, in accordance with at least one aspect of the present disclosure. The geo-fencing notification system 106 can include a hub 110 that is configured to wirelessly detect the presence of a wireless-enabled device 108. The wireless-enabled device 108 is intended to be carried by an individual so that the geo-fencing notification system 106 can track the individual as they enter and exit the virtual boundary 104 defined by the hub 110. To that end, the wireless-enabled device 108 can, in various aspects, be embodied as a fob, keychain, or another such item that can be affixed to or carried by an individual without substantial difficulty. The wireless-enabled device 108 can include a control circuit and/or transceiver that is configured to communicate via one or more communication protocols with the hub 110 to which it is paired. Further, it can be desirable for the wireless-enabled device 108 to be configured to wirelessly communicate with the hub 110 without including a rechargeable internal power source so that the wireless-enabled device 108 does not need to be recharged. Accordingly, the wireless-enabled device 108 can include, for example, a unique device ID (e.g., a Bluetooth MAC address) readable by the hub 110, for example.

The hub 110 can be embodied as an Internet-of-things hub, for example. The hub 110 can include a control circuit configured to establish a wireless connection with the wireless-enabled device 108 that has a definable signal strength utilizing a variety of different wireless techniques (e.g., personal area networks or local area networks) or communication protocols (e.g., Bluetooth, Bluetooth Low Energy, WFi, Zigbee, MQTT, or Mosquitto). For example, the control circuit of the hub 110 can include a memory 112, a processor 114, and a variety of other hardware components, such as one or more transceivers for communicably connecting the hub 110 to both the wireless-enabled device 108 and a back-end computer system 118 (e.g., via the Internet/router 116). The hub 110 can be programmed to send and receive data, such a detection events of the wireless-enabled device 108, to and from the back-end computer system 118, which can in turn be programmed to provide various notifications to a user device 120 (e.g., a user's smartphone). The back-end computer system 118 can include or be embodied as a database server, a web server, and/or a cloud computing system, for example.

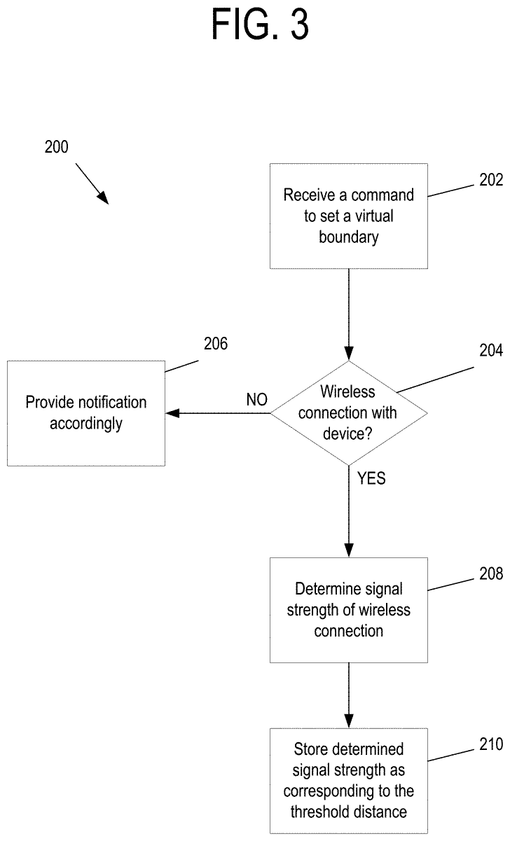

The hub 110 can be configured to define a geo-fence or virtual boundary 104 thereabout based upon the establishment of a wireless connection between the wireless-enabled device 108 and the hub 110. Further, the radius or size of the virtual boundary 104 can be customized according to the signal strength of the wireless connection, rather than being limited to the maximum distance at which the wireless connection can be established. The maximum distance of the wireless connection can vary based upon the particular communication protocol being utilized and other factors, but can be up to 100-200 meters, for example. The default range or size of the virtual boundary 104 can the maximum connection distance between the hub 110 and the wireless-enabled device 108. However, the user can also set the radius of the virtual boundary 104 by, for example, placing the wireless-enabled device 108 at the maximum distance from the hub 110 to which the user wants the virtual boundary 104 to extend and then indicating on a smartphone app, or other hub configuration interface method, that the geo-fencing notification system 106 should record the current position of the wireless-enabled device 108 as defining the perimeter of the virtual boundary 104. An example of such a process is described in greater detail below with respect to FIG. 3.

The hub 110 can be wirelessly connected to the back-end computer system 118 via the Internet/router 116. The back-end computer system 118 can be configured to store user settings and provide notifications to the user device(s) 120 that are associated with the particular hub 110. In one aspect, each user can have an account that it associated with the geo-fencing notification system 106. The hub 110 and user device(s) 120 can be assigned or otherwise associated with a user account, which can be stored by the back-end computer system 118. Upon the hub 110 wirelessly sensing when a wireless-enabled device 108 enters or leaves the virtual boundary 104, the hub 110 can transmit data accordingly to the back-end computer system 118. The back-end computer system 118 can then retrieve the data record indicating the user device(s) 120 assigned to the user account corresponding to the hub 110 from which the back-end computer system 118 just received data and then transmit a notification to the appropriate user device(s) 120 about the wireless-enabled device 108. Thus, the hub 110 serves as a broker by sensing the wireless-enabled device 108 and then transmitting data accordingly to the back-end computer system 118, which can then transmit a user notification. The user can enable or define various rules for when notifications are to be sent using a smartphone app on the user device 120. For example, the user can elect to receive a notification when a particular wireless-enabled device 108 enters the virtual boundary 104, exits the virtual boundary 104, has not entered or exited the virtual boundary 104 within a particular time frame, and so on. These rules can be executed by the hub 110, the back-end computer system 118, and/or the user device 120 (e.g., by an app thereon).

The wireless-enabled device 108 can store or include a unique indicator (e.g., a code) that only allows it to be recognized by (i.e., paired with) the hub 110. Furthermore, the hub 110 can distinguish between multiple wireless-enabled devices 108 that are paired with the hub 110 based upon each of their indicators. In one aspect, each wireless-enabled device 108 can be configured to transmit the indicator upon communication being established with the hub 110. The indicator can be embodied as, for example, an identifying bit pattern embedded within a transmitted signal. In one aspect, the wireless-enabled device 108 is configured to function without a rechargeable internal power source (so that it does not need to be charged). Further, the wireless-enabled device 108 can be configured to be communicably connectable solely to a compatible hub 110. Accordingly, the wireless-enabled device 108 itself is not connected to the Internet 116, but can be wirelessly detected by the hub 110, which can in turn be connected to the Internet 116 to relay detection events and other data.

The hub 110 can be programmed to set the diameter or size of the virtual boundary 104 based upon user input. In one aspect, the hub 110 can be programmed to set the diameter of the virtual boundary 104 by a user holding a wireless-enabled device 108 at the maximum distance to which the user wants the virtual boundary 104 to extend and then initiating a command to cause the geo-fencing notification system 106 to set the perimeter of the virtual boundary 104 accordingly. In other words, the user can take the wireless-enabled device 108 to the point at which the user wants the hub 110 to begin registering the presence of the wireless-enabled device 108 as within the virtual boundary 104 (which must be within the maximum communication range between the wireless-enabled device 108 and the hub 110) and then cause the geo-fencing notification system 106 to set the radius of the virtual boundary 104 to the distance at which the user is currently standing (with the wireless-enabled device 108) from the hub 110. For example, FIG. 3 illustrates a logic flow diagram of a process 200 of establishing a virtual boundary 104. In one aspect, the process 200 can be executed by the hub 110. The process 200 can be embodied as, for example, instructions stored in the memory 112 coupled to the processor 114 that, when executed by the processor 114, cause the hub 110 to perform the enumerated steps of the process 200. In other aspects, the process 200 can be executed by the back-end computer system 118, the user device 120, or various combinations of the hub 110, back-end computer system 118, and the user device 120. For brevity, the process 200 will be described as being executed by the hub 110; however, it should be understood that the process 200 can, in other aspects, be executed by and between other components of the geo-fencing notification system 106. In the following description of the process 200, reference should also be made to FIG. 2.

Accordingly, a hub 110 executing the process 200 can receive 202 a user command to establish a virtual boundary 104. The command can be input via an app running on a user's smartphone (i.e., user device 120) that relays the command to the hub 110 through the back-end computer system 118. In one aspect, the user can input an individual identity of the wireless-enabled device 108 for which the virtual boundary 104 is being set. Therefore, different sized or configured virtual boundaries 104 can be set for different individuals based upon a unique identity associated with each of the wireless-enabled devices 108 that have been or will be associated with the hub 110.

Accordingly, the hub 110 can determine 204 whether there is a wireless connection between the wireless-enabled device 108 and the hub 110. If there is not a wireless connection between the wireless-enabled device 108 and the hub 110 (e.g., the wireless-enabled device 108 is out of communication range of the hub 110), then the process 200 can proceed along the NO branch and the hub 110 can then provide 206 a notification indicating the lack of a compatible wireless-enabled device 108 within detection range of the hub 110. If there is a wireless connection between the wireless-enabled device 108 and the hub 110, then the process 200 can proceed along the YES branch and the hub 110 can then determine 208 the signal strength of the wireless connection. The hub 110 can determine 208 the wireless connection signal strength utilizing a variety of techniques known in the field for various wireless connection types.

Accordingly, the hub 110 can store 210 the present signal strength of the wireless connection between the wireless-enabled device 108 and the hub 110. Because the wireless signal strength between two devices corresponds (at least in part) to the distance between the devices, the recorded signal strength thus corresponds to the distance between the wireless-enabled device 108 and the hub 110. This distance is thus the threshold distance demarcating the virtual boundary 104 about the hub 110. Thereafter, if the signal strength of the wireless connection between the wireless-enabled device 108 (or another similarly configured wireless-enabled device 108) and the hub 110 meets or exceeds the recorded signal strength (i.e., the threshold signal strength), then the wireless-enabled device 108 is determined to be within the virtual boundary 104 (i.e., at or equal to the threshold distance from the hub 110). Correspondingly, if there is no wireless connection between the wireless-enabled device 108 and the hub 110 or the wireless connection signal strength is less than the threshold signal strength, then the wireless-enabled device 108 is determined to be outside the virtual boundary 104. The hub 110 or another component of the geo-fencing notification system 106 can be programmed to execute logic to provide notifications to users and/or take other actions based upon the presence or lack thereof of the wireless-enabled device 108 within the virtual boundary 104, which are described below. The threshold signal strength can be stored in the memory 112, for example. The step of storing 210 the present signal strength can include recording the signal strength in a database (e.g., in the memory 112), transiently storing the signal strength (e.g., in random access memory (RAM)) as a part of translating the signal strength into another parameter that is recorded or stored by the hub 110, and so on.

In sum, the hub 110 can be configured to set a virtual boundary 104 by recording the current signal strength between the hub 110 and the wireless-enabled device 108 as the threshold signal strength that corresponds to the edge of the virtual boundary 104. Thereafter, when the signal strength between the hub 110 and the wireless-enabled device 108 is at least the threshold signal strength value, the wireless-enabled device 108 is considered to be within the virtual boundary 104. Conversely, when the signal strength between the hub 110 and the wireless-enabled device 108 is less than the threshold signal strength value (or the hub 110 and the wireless-enabled device 108 are not communicably connected to each other), the wireless-enabled device 108 is considered to be outside the virtual boundary 104. Therefore, a virtual boundary 104 can be defined based upon wireless signal strength. The hub 100 can be programmed to determine the signal strength of the wireless connection utilizing a variety of techniques known in the field for various wireless connection types.

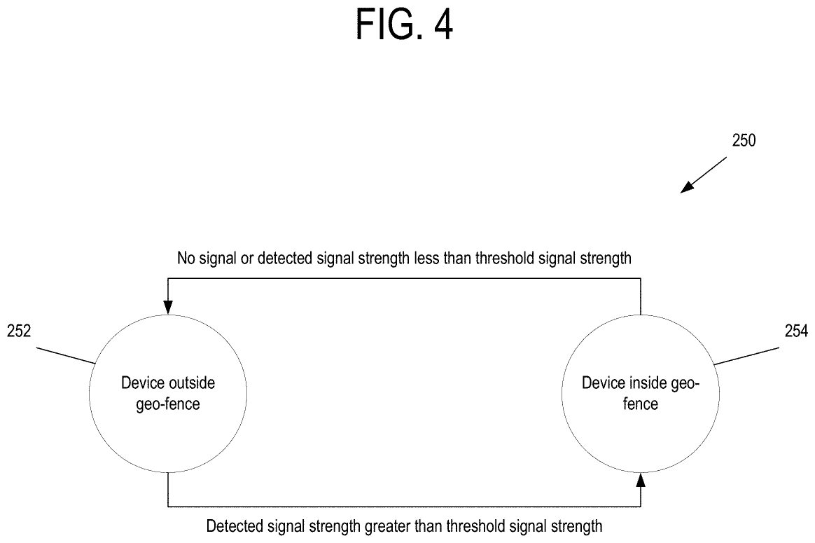

In one aspect, the geo-fencing notification system 106 can be exemplified as a state machine with respect to each of the wireless-enabled devices 108 that are paired with the hub 110, as is shown in the state machine diagram 250 of FIG. 4. In particular, the geo-fencing notification system 106 can be programmed to transition between a first state 252 and a second state 254 depending upon the detected movement of the wireless-enabled device 108 with respect to the virtual boundary 104. For example, the geo-fencing notification system 106 can be programmed to transition from the first state 252 to the second state 254 upon the hub 110 determining that the wireless signal strength between the wireless-enabled device 108 and the hub 110 is greater than (or equal to) the threshold signal strength, which can be set by the process 200 illustrated in FIG. 3. The hub 110 can be programmed to periodically (e.g., every minute) check the signal strength of the wireless connection with the wireless-enabled device 108, just as the wireless-enabled device 108 can be programmed to periodically (e.g., every 15 seconds) transmit a wireless signal to be received by the hub 110. Further, the geo-fencing notification system 106 can be programmed to transition from the second state 254 to the first state 252 upon the hub 110 determining that there is no wireless connection or the wireless signal strength between the wireless-enabled device 108 and the hub 110 is less than (or equal to) the threshold signal strength. Logic being executed by the by the hub 110, back-end computer system 118, and/or user device 120 can periodically determine or query the state of the geo-fencing notification system 106 with respect to each of the paired wireless-enabled devices 108 and then take action accordingly.

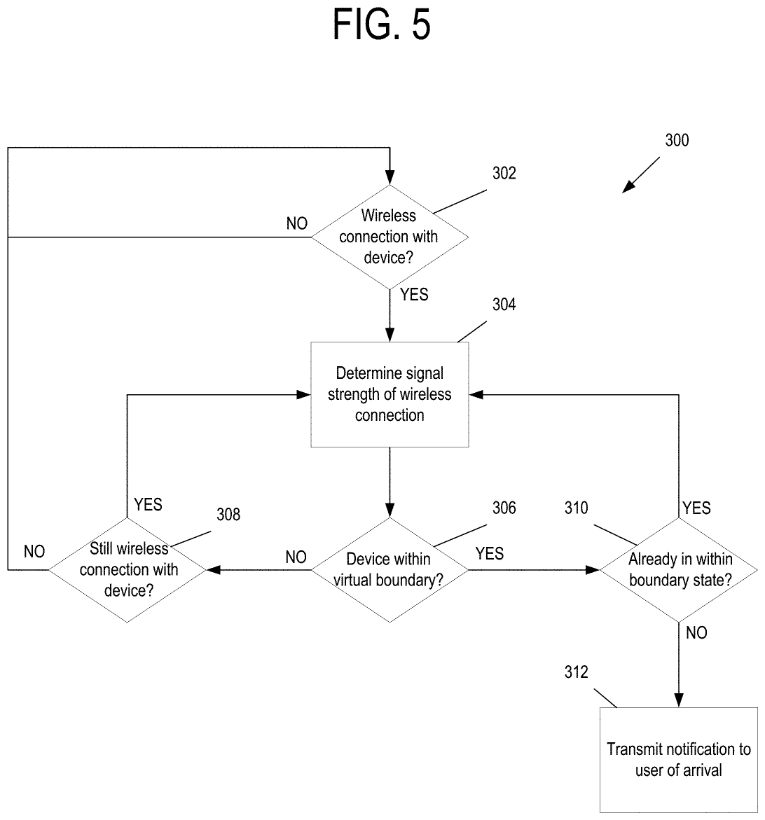

In one aspect, the geo-fencing notification system 106 can be configured to provide a notification to users upon a holder of a wireless-enabled device 108 paired with the hub 110 entering the defined virtual boundary 104. This aspect can be utilized to, for example, provide a notification to parents upon their children coming home after school. This aspect could also be utilized in an enterprise setting to, for example, provide a notification to parents and/or school personnel when a child arrives at school (e.g., to verify attendance). In one such implementation, the hub 110 and/or another components of the geo-fencing notification system 106 can be configured to execute the process 300 illustrated in FIG. 5.

Accordingly, a hub 110 executing the process 300 can monitor for one or more wireless-enabled devices 108 that have previously been paired with the hub 110 by determining 302 whether a wireless connection has been established with such a wireless-enabled device 108. The hub 110 can determine 302 whether a wireless connection has been established by, for example, monitoring for a handshake transmission from the wireless-enabled device 108. If a wireless connection has not been established, then the process 300 can proceed along the NO branch and the hub 110 can continue monitoring for a compatible wireless-enabled device 108. If a wireless connection has been established, then the process 300 can proceed along the YES branch and the hub 110 can determine 304 the signal strength of the detected wireless connection. Further, the hub 110 can record the timestamp of the determination of whether there is a wireless connection between the wireless-enabled device 108 and the hub 110.

Accordingly, the hub 110 can determine 306 whether the wireless-enabled device 108 is within the virtual boundary 104. In one example, the hub 110 can make this determination by comparing the detected signal strength to the threshold signal strength for the virtual boundary 104, which could have been previously established via the process 200 illustrated in FIG. 3, for example. In one aspect, the size or configuration of the virtual boundary 104 can vary for different wireless-enabled devices 108. In this aspect, the hub 110 can, for example, further receive an identifier from the wireless-enabled device 108 upon being communicably connected therewith. The hub 110 can then retrieve the threshold signal strength associated with the particular device identifier from, for example, the memory 112 or the back-end computer system 118. The hub 110 can then determine 306 whether the wireless-enabled device 108 is within the virtual boundary 104 defined for the retrieved identifier according to the retrieved threshold signal strength. In another aspect, the size or configuration of the virtual boundary 104 can be set for the particular hub 110 (i.e., not customized for each individual wireless-enabled device 108 paired therewith). In this aspect, the hub 110 can retrieve the universal threshold signal strength associated with the hub 110 from, for example, the memory 112 or the back-end computer system 118. The hub 110 can then determine 306 whether the wireless-enabled device 108 is within the virtual boundary 104 defined for the hub 110 according to the retrieved threshold signal strength. Further, the hub 110 can record the timestamp of the determination of whether the wireless-enabled device 108 is within the virtual boundary 104.

If the wireless-enabled device 108 is not within the virtual boundary 104, then the process 300 can proceed along the NO branch and the hub 110 can determine 308 whether the wireless-enabled device 108 and the hub 110 are still connected (e.g., whether the wireless-enabled device 108 has gone outside of the maximum communication range with the hub 110, which can be, for example, 200 meters). If the wireless-enabled device 108 and the hub 110 are still connected, then the process 300 can proceed along the YES branch and the hub 110 can continue determining 304 the signal strength of the wireless connection. If the wireless-enabled device 108 and the hub 110 are not still connected, then the process 300 can proceed along the NO branch and the hub 110 can resume monitoring for a wireless connection.

If the wireless-enabled device 108 is within the virtual boundary 104, then the process 300 can proceed along the YES branch and the hub 110 can determine 310 whether the geo-fencing notification system 106 has already determined that the wireless-enabled device 108 is present within the virtual boundary 104. The hub 110 can be configured to determine 310 whether the wireless-enabled device 108 has already been determined to be within the virtual boundary 104 according to, for example, the state of the geo-fencing notification system 106 or by comparing the timestamp of the determination that the wireless-enabled device 108 is present within the virtual boundary 104 to the timestamp(s) of previously recorded activities. For example, in aspects where the geo-fencing notification system 106 can be modeled as a state machine (e.g., as described in connection with FIG. 4), the hub 110 can determine 310 whether the geo-fencing notification system 106 is already in a “within boundary” state. If the geo-fencing notification system 106 is already in the “within boundary” state, the process 300 can proceed along the YES branch and the hub 110 can resume monitoring the wireless connection signal strength. If the geo-fencing notification system 106 is not already in the “within boundary” state (i.e., it is presently in the “outside boundary” state), the process 300 can proceed along the NO branch and the hub 110 can transmit 312 a notification to a user indicating that the holder of the wireless-enabled device 108 has entered the virtual boundary 104. In one aspect, the hub 110 can transmit data to the back-end computer system 118, which can in turn be configured to push a notification to a user's smartphone (i.e., user device 120) indicating that the wireless-enabled device 108 has entered the virtual boundary 104. In one aspect, the notification can further include the individual identity (e.g., name) corresponding to the identifier received by the hub 110 from the wireless-enabled device 108 so that the user can ascertain which individual the notification corresponds to, which can be useful in cases where multiple wireless-enabled devices 108 associated with different individuals have been paired with the hub 110.

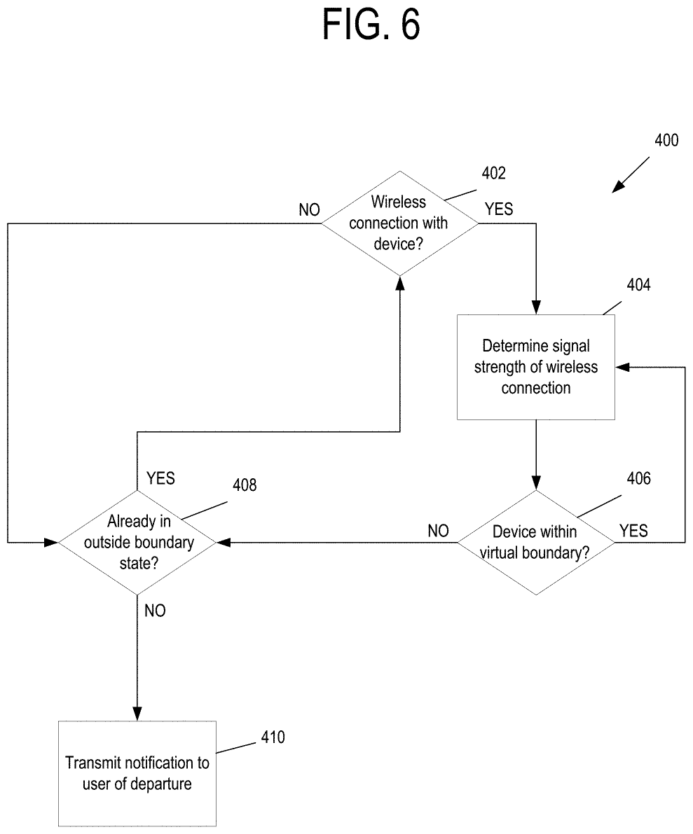

In one aspect, the geo-fencing notification system 106 can be configured to provide a notification to users upon a holder of a wireless-enabled device 108 paired with the hub 110 leaving the defined virtual boundary 104. This aspect can be utilized to, for example, provide a notification to caregivers if a subject individual (e.g., a family member suffering from Alzheimer's or a medical ward patient) leaves a designated area (e.g., a safe area). This aspect could also be utilized to, for example, provide a notification if a pet escapes the house. This aspect could still also be utilized in an enterprise setting to, for example, provide a notification when a worker departs a job site to inform the employer. In one such implementation, the hub 110 and/or another components of the geo-fencing notification system 106 can be configured to execute the process 400 illustrated in FIG. 6.

Accordingly, a hub 110 executing the process 400 can monitor for one or more wireless-enabled devices 108 that have previously been paired with the hub 110 by determining 402 whether a wireless connection has been established with such a wireless-enabled device 108. If a wireless connection has not been established, then the process 400 can proceed along the NO branch and the hub 110 can determine 408 whether the geo-fencing notification system 106 has already determined that the wireless-enabled device 108 is not present within the virtual boundary 104, as described in greater detail below. If a wireless connection has been established, then the process 400 can proceed along the YES branch and the hub 110 can determine 404 the signal strength of the detected wireless connection. Further, the hub 110 can record the timestamp of the determination of whether there is a wireless connection between the wireless-enabled device 108 and the hub 110.

Accordingly, the hub 110 can determine 406 whether the wireless-enabled device 108 is within the virtual boundary 104, as described above with respect to the process 300 illustrated in FIG. 5. If the wireless-enabled device 108 is within the virtual boundary 104, then the process 400 can proceed along the YES branch and the hub 110 can continue monitoring the wireless connection signal strength. If the wireless-enabled device 108 is not within the virtual boundary 104, then the process 400 can proceed along the NO branch and the hub 110 can determine 408 whether the geo-fencing notification system 106 has already determined that the wireless-enabled device 108 is present within the virtual boundary 104. Further, the hub 110 can record the timestamp of the determination of whether the wireless-enabled device 108 is within the virtual boundary 104. The hub 110 can be configured to determine 408 whether the wireless-enabled device 108 has already been determined to be outside the virtual boundary 104 according to, for example, the state of the geo-fencing notification system 106 or by comparing the timestamp of the determination that the wireless-enabled device 108 is outside of the virtual boundary 104 to the timestamp(s) of previously recorded activities. For example, in aspects where the geo-fencing notification system 106 can be modeled as a state machine (e.g., as described in connection with FIG. 4), the hub 110 can determine 408 whether the geo-fencing notification system 106 is already in a “outside boundary” state. If the geo-fencing notification system 106 is already in the “outside boundary” state, the process 400 can proceed along the YES branch and the hub 110 can resume monitoring the wireless connection status. If the geo-fencing notification system 106 is not in the “outside boundary” state (i.e., it is presently in the “within boundary” state), the process 400 can proceed along the NO branch and the hub 110 can transmit 410 a notification to a user, in a manner as described above with respect to the process 300 illustrated in FIG. 5, indicating that the holder of the wireless-enabled device 108 has left the virtual boundary 104. As is further described above with respect to the process 300 illustrated in FIG. 5, the transmitted 410 notification can further include the individual identity. The transmitted 410 notification can be in the form of a text message (e.g., an SMS message, an RCS message, or a message via a messaging app, such as WhatsApp or iMessage), an email, and/or a push notification.

In one aspect, the geo-fencing notification system 106 can be configured to provide a notification to users if a holder of a wireless-enabled device 108 paired with the hub 110 is either within or not within the defined virtual boundary 104 at a particular time. This aspect can be utilized to, for example, provide a notification to parents if their children have not left for school by a particular time. This aspect could also be utilized to, for example, provide a notification to parents if their children have not returned home by their curfew. In such aspects, the processes 300, 400 described in connection with FIGS. 5 and 6 can be configured to be executed at particular times or the processes 300, 400 can be configured to only transmit 312, 410 user notifications if the current time matches a selected time, for example.

As with the process 200 described in connection with FIG. 3, the processes 300, 400 described in connection with FIGS. 5 and 6 can be executed by the hub 110. The processes 300, 400 can be embodied as, for example, instructions stored in the memory 112 coupled to the processor 114 that, when executed by the processor 114, cause the hub 110 to perform the enumerated steps of the processes 300, 400. In other aspects, the processes 300, 400 can be executed by the back-end computer system 118, the user device 120, or various combinations of the hub 110, back-end computer system 118, and the user device 120.

The various logic and/or algorithms described above can be executed individually or concurrently by the geo-fencing notification system 106. Further, other logic and/or algorithms can be executed by the geo-fencing notification system 106.

The present described geo-fencing notification system 106 provides several key benefits over other systems. First, the geo-fencing notification system 106 does not utilize GPS in any manner, which obviates the need for the wireless-enabled device 108 to include a GPS receiver, which would in turn require that the wireless-enabled device 108 be recharged regularly. Utilizing a wireless-enabled device 108 that does not need to be recharged is a major benefit for implementations of this system for use with children and individuals with special needs or cognitive disabilities because such individuals cannot be relied upon to regularly recharge electronic devices. One would not want the wireless-enabled device 108 to die because it had not been recharged and thus lose the ability to track the individual's location. Not utilizing GPS is also beneficial because it allows the geo-fencing notification system 106 to be utilized in environments that may have poor GPS signal coverage (such as rural areas, indoors, areas with metal roofing, or urban apartments), and also avoids GPS-location tracking privacy risks. Second, the geo-fencing notification system 106 does not require the use of cellular networks or a smartphone by the individuals being tracked. This is, once again, a major benefit for tracking individuals whom one does not wish to give a smartphone (e.g., young children) or could not be relied upon to use the smartphone effectively (e.g., individuals with cognitive disabilities). Third, the geo-fencing notification system 106 does not require the manipulation of physical security, such as locking or unlocking doors. This is beneficial because it allows one to receive notifications as to tracked individuals regardless of whether they, for example, unlock a door to leave the building. Systems that rely upon such triggers could fail if, for example, the door was already unlocked, or if the user does not execute this manual action. Fourth, the geo-fencing notification system 106 functions completely automatically once the initial setup steps have been performed (e.g., the size of the virtual boundary 104 has been set and the desired tracking rules have been enabled); notifications are automatically triggered and sent to the user(s) without requiring any further interaction with or manipulation of the geo-fencing notification system 106. Fifth, the geo-fencing notification system 106 does not require that users have a cellphone calling or data plan, which allows the geo-fencing notification system 106 to be utilized internationally when cell service may not be available or by individuals who do not have a cellphone plan. In particular, the hub 110 can be connected to the back-end computer system 118 through, e.g., a WiFi network and the client device 120 through which notifications are received can likewise be connected to, e.g., a WiFi network or another non-cellular network, thereby allowing the geo-fencing notification system 106 to be fully functional without a cellphone calling or data plan. Sixth, the geo-fencing notification system 106 functions in a stand-alone manner and is not required to be utilized in conjunction with a particular smart home ecosystem, such as Samsung's SmartThings or Google's Home products.

While several forms have been illustrated and described, it is not the intention of Applicant to restrict or limit the scope of the appended claims to such detail. Numerous modifications, variations, changes, substitutions, combinations, and equivalents to those forms may be implemented and will occur to those skilled in the art without departing from the scope of the present disclosure. Moreover, the structure of each element associated with the described forms can be alternatively described as a means for providing the function performed by the element. It is therefore to be understood that the foregoing description and the appended claims are intended to cover all such modifications, combinations, and variations as falling within the scope of the disclosed forms. The appended claims are intended to cover all such modifications, variations, changes, substitutions, modifications, and equivalents.

The foregoing detailed description has set forth various forms of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, and/or examples can be implemented, individually and/or collectively, by a wide range of hardware, software, firmware, or virtually any combination thereof. Those skilled in the art will recognize that some aspects of the forms disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and designing the circuitry and/or writing the code for the software and or firmware would be well within the skill of one skilled in the art in light of this disclosure. In addition, those skilled in the art will appreciate that the mechanisms of the subject matter described herein are capable of being distributed as one or more program products in a variety of forms, and an illustrative form of the subject matter described herein applies regardless of the particular type of signal-bearing medium used to actually carry out the distribution.

Instructions used to program logic to perform various disclosed aspects can be stored within a memory in the system, such as dynamic random access memory (DRAM), cache, flash memory, or other storage. Furthermore, the instructions can be distributed via a network or by way of other computer-readable media. Thus a machine-readable medium may include any mechanism for storing or transmitting information in a form readable by a machine (e.g., a computer) but is not limited to floppy diskettes, optical disks, compact disc, read-only memory (CD-ROMs), magneto-optical disks, read-only memory (ROMs), random access memory (RAM), erasable programmable read-only memory (EPROM), electrically erasable programmable read-only memory (EEPROM), magnetic or optical cards, flash memory, or a tangible, machine-readable storage used in the transmission of information over the Internet via electrical, optical, acoustical, or other forms of propagated signals (e.g., carrier waves, infrared signals, digital signals). Accordingly, the non-transitory computer-readable medium includes any type of tangible machine-readable medium suitable for storing or transmitting electronic instructions or information in a form readable by a machine (e.g., a computer).

As used in any aspect herein, the term “control circuit” may refer to, for example, hardwired circuitry, programmable circuitry (e.g., a computer processor including one or more individual instruction processing cores, processing unit, processor, microcontroller, microcontroller unit, controller, digital signal processor (DSP), programmable logic device (PLD), programmable logic array (PLA), or field programmable gate array (FPGA)), state machine circuitry, firmware that stores instructions executed by programmable circuitry, and any combination thereof. The control circuit may, collectively or individually, be embodied as circuitry that forms part of a larger system, for example, an integrated circuit (IC), an application-specific integrated circuit (ASIC), a system on-chip (SoC), desktop computers, laptop computers, tablet computers, servers, smart phones, etc. Accordingly, as used herein, “control circuit” includes, but is not limited to, electrical circuitry having at least one discrete electrical circuit, electrical circuitry having at least one integrated circuit, electrical circuitry having at least one application specific integrated circuit, electrical circuitry forming a general-purpose computing device configured by a computer program (e.g., a general-purpose computer configured by a computer program that at least partially carries out processes and/or devices described herein, or a microprocessor configured by a computer program that at least partially carries out processes and/or devices described herein), electrical circuitry forming a memory device (e.g., forms of RAM), and/or electrical circuitry forming a communications device (e.g., a modem, communications switch, or optical-electrical equipment). Those having skill in the art will recognize that the subject matter described herein may be implemented in an analog or digital fashion or some combination thereof.

As used in any aspect herein, the term “logic” or “algorithm” may refer to an app, software, firmware, and/or circuitry configured to perform any of the aforementioned operations. Software may be embodied as a software package, code, instructions, instruction sets, and/or data recorded on non-transitory computer-readable storage medium. Firmware may be embodied as code, instructions, or instruction sets and/or data that are hard-coded (e.g., nonvolatile) in memory devices. A “step” of the logic or algorithm can refer to a manipulation of physical quantities and/or logic states that may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities and/or states.

As used in any aspect herein, the terms “component,” “system,” “module,” and the like can refer to a computer-related entity, either hardware, a combination of hardware and software, software, or software in execution.

A network may include a packet switched network. The communication devices may be capable of communicating with each other using a selected packet switched network communications protocol. One example communications protocol may include an Ethernet communications protocol that may be capable permitting communication using a Transmission Control Protocol/Internet Protocol (TCP/IP). The Ethernet protocol may comply or be compatible with the Ethernet standard published by the Institute of Electrical and Electronics Engineers (IEEE) titled “IEEE 802.3 Standard,” published in December 2008, and/or later versions of this standard. Alternatively or additionally, the communication devices may be capable of communicating with each other using an X.25 communications protocol. The X.25 communications protocol may comply or be compatible with a standard promulgated by the International Telecommunication Union-Telecommunication Standardization Sector (ITU-T). Alternatively or additionally, the communication devices may be capable of communicating with each other using a frame relay communications protocol. The frame relay communications protocol may comply or be compatible with a standard promulgated by the Consultative Committee for International Telegraph and Telephone (CCITT) and/or the American National Standards Institute (ANSI). Alternatively or additionally, the transceivers may be capable of communicating with each other using an Asynchronous Transfer Mode (ATM) communications protocol. The ATM communications protocol may comply or be compatible with an ATM standard published by the ATM Forum titled “ATM-MPLS Network Interworking 2.0,” published in August 2001, and/or later versions of this standard. Of course, different and/or after-developed connection-oriented network communication protocols are equally contemplated herein.

Unless specifically stated otherwise as apparent from the foregoing disclosure, it is appreciated that, throughout the foregoing disclosure, discussions using terms such as “determining,” “receiving,” “transmitting,” “comparing,” or the like refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

One or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general, such a construction is intended in the sense one having skill in the art would understand the convention (e.g., “a system having at least one of A, B, and C” would include, but not be limited to, systems that have A alone, B alone, C alone, A and B together, A and C together, B and C together, and/or A, B, and C together, etc.). In those instances where a convention analogous to “at least one of A, B, or C, etc.” is used, in general, such a construction is intended in the sense one having skill in the art would understand the convention (e.g., “a system having at least one of A, B, or C” would include, but not be limited to, systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically be understood to include the possibilities of “A” or “B” or “A and B.”

With respect to the appended claims, those skilled in the art will appreciate that recited operations therein may generally be performed in any order. Also, although various operational flow diagrams are presented in a sequence(s), it should be understood that the various operations may be performed in other orders than those that are illustrated or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures, or characteristics may be combined in any suitable manner in one or more aspects.

Any patent application, patent, non-patent publication, or other disclosure material referred to in this specification and/or listed in any Application Data Sheet is incorporated by reference herein, to the extent that the incorporated materials are not inconsistent herewith. As such, and to the extent necessary, the disclosure as explicitly set forth herein supersedes any conflicting material incorporated herein by reference. Any material, or portion thereof, that is said to be incorporated by reference herein but conflicts with existing definitions, statements, or other disclosure material set forth herein will only be incorporated to the extent that no conflict arises between that incorporated material and the existing disclosure material.

In summary, numerous benefits have been described that result from employing the concepts described herein. The foregoing description of the one or more forms has been presented for purposes of illustration and description. It is not intended to be exhaustive or limiting to the precise form disclosed. Modifications or variations are possible in light of the above teachings. The one or more forms were chosen and described in order to illustrate principles and practical application to thereby enable one of ordinary skill in the art to utilize the various forms and with various modifications as are suited to the particular use contemplated. It is intended that the claims submitted herewith define the overall scope.

1. A hub configured to communicably connect via a wireless communication protocol to a wireless-enabled device, the hub comprising:
a processor; and
a memory coupled to the processor, the memory storing instructions that, when executed by the processor, cause the hub to:
receive a command to set a threshold distance;
determine a signal strength of a wireless connection between the wireless-enabled device and the hub;
store the signal strength corresponding to the threshold distance as a threshold signal strength;
wherein the threshold distance defines a virtual boundary about the hub; and
after recordation of the threshold signal strength:
determine the wireless connection established between the hub and the wireless-enabled device;
determine the signal strength of the wireless connection;
compare the signal strength of the wireless connection to the threshold signal strength; and
transmit a notification to a recipient based on the comparison of the signal strength and the threshold signal strength;
wherein the notification indicates that the wireless-enabled device has crossed the virtual boundary.

2. The hub of claim 1, wherein the instructions, when executed by the processor, cause the hub to transmit the notification in response to the wireless-enabled device leaving the virtual boundary.

3. The hub of claim 1, wherein the instructions, when executed by the processor, cause the hub to transmit the notification in response to the wireless-enabled device entering the virtual boundary.

4. The hub of claim 1, wherein the instructions, when executed by the processor, cause the hub to:
determine a current time;
compare the current time to a selected time; and
transmit the notification in response to the wireless-enabled device being within the virtual boundary based on the comparison of the current time and the selected time.

5. The hub of claim 1, wherein the instructions, when executed by the processor, cause the hub to:
receive an identifier from the wireless-enabled device upon establishment of the wireless connection;
retrieve a user identity corresponding to the identifier;
wherein the notification indicates the user identity.

6. The hub of claim 1, wherein the command to set the threshold distance can be received from at least one of a smartphone application or a website.

7. The hub of claim 1, wherein the notification comprises at least one of a push notification provided via a smartphone application, an email, or a text message.

8. The hub of claim 1, wherein the wireless communication protocol comprises Bluetooth Low Energy.

9. A back-end computer system configured to communicably connect to a hub and a client device, the hub configured to communicably connect via a wireless communication protocol to a wireless-enabled device, the back-end computer system comprising:
a processor; and
a memory coupled to the processor, the memory storing instructions that, when executed by the processor, cause the back-end computer system to:
receive, from the client device, a command to set a threshold distance;
transmit the command to the hub;
receive, from the hub, a signal strength of a wireless connection between the wireless-enabled device and the hub;
store the signal strength corresponding to the threshold distance as a threshold signal strength;
wherein the threshold distance defines a virtual boundary about the hub; and
after recordation of the threshold signal strength:
receive, from the hub, the signal strength of the wireless connection;
compare the signal strength of the wireless connection to the threshold signal strength; and
transmit a notification to the client device based on the comparison of the signal strength and the threshold signal strength;
wherein the notification indicates that the wireless-enabled device has crossed the virtual boundary.

10. The back-end computer system of claim 9, wherein the instructions, when executed by the processor, cause the back-end computer system to transmit the notification in response to the wireless-enabled device leaving the virtual boundary.

11. The back-end computer system of claim 9, wherein the instructions, when executed by the processor, cause the back-end computer system to transmit the notification in response to the wireless-enabled device entering the virtual boundary.

12. The back-end computer system of claim 9, wherein the instructions, when executed by the processor, cause the back-end computer system to:
determine a current time;
compare the current time to a selected time; and
transmit the notification in response to the wireless-enabled device being within the virtual boundary based on the comparison of the current time and the selected time.

13. The back-end computer system of claim 9, wherein the instructions, when executed by the processor, cause the back-end computer system to:
receive, from the hub, an identifier from the wireless-enabled device upon establishment of the wireless connection;
retrieve a user identity corresponding to the identifier;
wherein the notification indicates the user identity.

14. The back-end computer system of claim 9, wherein the client device comprises a smartphone and the command to set the threshold distance can be sent via at least one of a smartphone application or a website.

15. The back-end computer system of claim 9, wherein the notification comprises at least one of a push notification provided via a smartphone application, an email, or a text message.

16. The back-end computer system of claim 9, wherein the wireless communication protocol comprises Bluetooth Low Energy.

17. A computer-implemented method for tracking a wireless-enabled device via a hub, the hub configured to communicably connect via a wireless communication protocol to the wireless-enabled device, the method comprising:
receiving, by the hub, a command to set a threshold distance;
determining, by the hub, a signal strength of a wireless connection between the wireless-enabled device and the hub;
storing, by the hub, the signal strength corresponding to the threshold distance as a threshold signal strength;
wherein the threshold distance defines a virtual boundary about the hub; and
after recordation of the threshold signal strength:
determining, by the hub, the wireless connection established between the hub and the wireless-enabled device;
determining, by the hub, the signal strength of the wireless connection;
comparing, by the hub, the signal strength of the wireless connection to the threshold signal strength; and
transmitting, by the hub, a notification to a recipient based on the comparison of the signal strength and the threshold signal strength;
wherein the notification indicates that the wireless-enabled device has crossed the virtual boundary.

18. The computer-implemented method of claim 17, wherein transmitting the notification to the recipient further comprises transmitting, by the hub, the notification in response to the wireless-enabled device leaving the virtual boundary.

19. The computer-implemented method of claim 17, wherein transmitting the notification to the recipient further comprises transmitting, by the hub, the notification in response to the wireless-enabled device entering the virtual boundary.

20. The computer-implemented method of claim 17, further comprising:
determining, by the hub, a current time;
comparing, by the hub, the current time to a selected time; and
transmitting, by the hub, the notification in response to the wireless-enabled device being within the virtual boundary based on the comparison of the current time and the selected time.
